(19) United States
(12) Patent Application Publication
(10) Pub. No.: US 2008/0112165 A1
(43) Pub. Date: May 15, 2008

(54) LIGHT-EMITTING DEVICE

(75) Inventors: Yuki MORI, Higashiomi (JP); Akira Miyake, Higashiomi (JP); Shingo Matsuura, Higashiomi (JP); Kousuke Katabe, Higashiomi (JP)

Correspondence Address: PROCOPIO, CORY, HARGREAVES & SAVITCH LLP, 530 B STREET, SUITE 2100, SAN DIEGO, CA, 92101, US

(73) Assignee: Kyocera Corporation, Kyoto (JP)

(21) Appl. No.: 11/940,769

(22) Filed: Nov. 15, 2007

(30) Foreign Application Priority Data
Nov. 15, 2006 (JP) 2006-309450
Mar. 28, 2007 (JP) 2007-085154

(51) Int. Cl. F21V 13/04; F21V 7/04

(52) U.S. Cl. 362/241; 362/227; 362/245

(57) ABSTRACT

A lighting apparatus includes a substrate, a plurality of light-emitting chips and a light-emitting member. The substrate has a layer including a base material and a medium. The base material is formed of an inorganic material and includes a plurality of cells. The medium is provided in the cells and has a refractive index lower than that of the inorganic material. The light-emitting chips are made of a semiconductor material and mounted on the substrate. The light-emitting member includes a fluorescent material and is provided above the light-emitting chips.

### CROSS-REFERENCE TO RELATED APPLICATION

This application claims priority under 35 U.S.C. §119 to Japanese Application No. 2006-309450, filed Nov. 15, 2006 and Japanese Application No. 2007-085154, filed Mar. 28, 2007, which are hereby incorporated by reference.

### BACKGROUND OF THE INVENTION

1. Field of the Invention

The present invention relates to a lighting apparatus which has light-emitting chip.

2. Description of the Related Art

In recent years, development of lighting apparatuses having a light-emitting chip, such as a light-emitting diode, has advanced. A lighting apparatus includes a light-emitting member that emits second light in accordance with first light emitted from the light-emitting chip. For example, in the field of illumination, the area of the light-emitting member has been increased.

The lighting apparatus having the light-emitting member is expected to suppress the emission of non-uniform light. Especially in a lighting apparatus having a larger light emission area, reducing the emission of non-uniform light from a light-emitting member is expected.

### SUMMARY OF THE INVENTION

According to an aspect of the present invention, a lighting apparatus includes a substrate, a plurality of light-emitting chips and a light-emitting member. The substrate has a layer including a base material and a medium. The base material is formed of an inorganic material and includes a plurality of cells. The medium is provided in the cells and has a refractive index lower than that of the inorganic material. The light-emitting chips are made of a semiconductor material and mounted on the substrate. The light-emitting member includes a fluorescent material and is provided above the light-emitting chips.

### BRIEF DESCRIPTION OF THE DRAWINGS

FIG. 1 shows the concept of an embodiment of the present invention.

FIG. 2 is a plan view of a lighting apparatus according to the embodiment.

FIG. 3 is a cross-sectional view of the lighting apparatus, taken along line A-A′ in FIG. 2.

FIG. 4 is an exploded view of the lighting apparatus shown in FIG. 2.

FIG. 5 is an explanatory view of a substrate 11 shown in FIG. 2.

FIG. 6 is a view explaining how light travels in the lighting apparatus shown in FIG. 2.

FIG. 7 is a view explaining how light travels in the lighting apparatus shown in FIG. 2.

FIG. 9 shows a production method for the lighting apparatus according to the embodiment.

FIG. 10 shows the production method for the lighting apparatus according to the embodiment.

FIG. 11 shows a lighting apparatus according to another embodiment.

FIG. 12 shows a lighting apparatus according to a further embodiment.

FIG. 13 shows a production method for the lighting apparatus shown in FIG. 12.

FIG. 14 shows a lighting apparatus according to a further embodiment.

FIG. 15 shows a lighting apparatus according to a still further embodiment.

FIG. 16 is a view explaining the lighting apparatus shown in FIG. 15.

### DESCRIPTION OF THE PREFERRED EMBODIMENTS

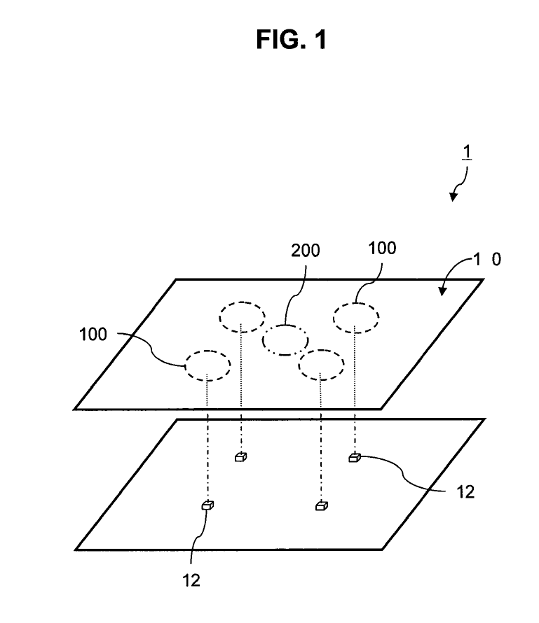

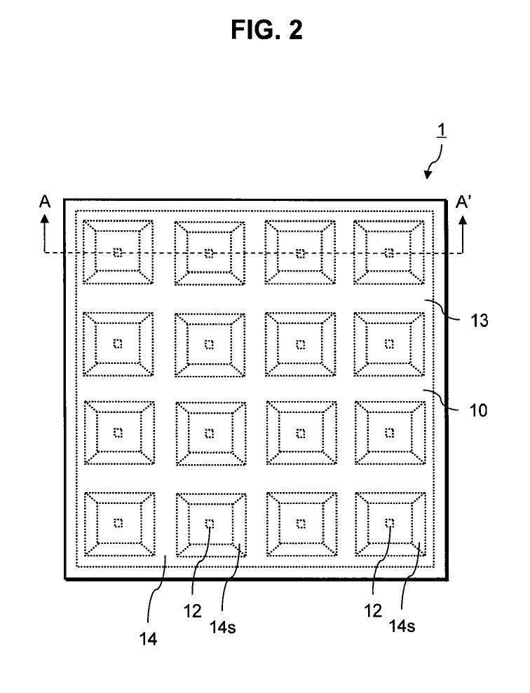

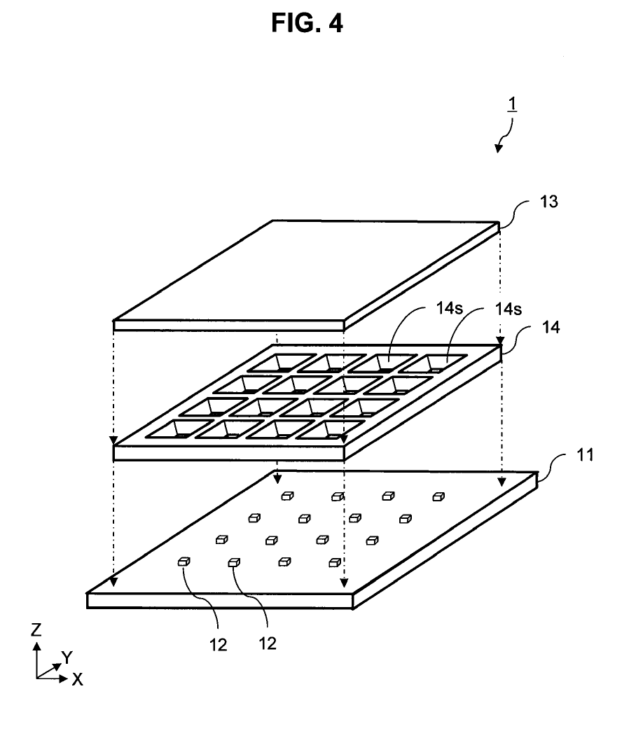

Embodiments of the present invention will be described below with reference to the drawings. The concept of a lighting apparatus 1 according to an embodiment is described with reference to FIG. 1. The lighting apparatus 1 of the embodiment relates to a surface light source. In the lighting apparatus 1, non-uniform light emission from a light-emitting surface 10 is reduced. The light-emitting surface 10 of the lighting apparatus 1 includes a plurality of regions 100 disposed immediately above a plurality of light-emitting chips 12, and a region 200 provided among the regions 100. Non-uniform light emission from the light-emitting surface 10 including the regions 100 and the region 200 is reduced. In the light-emitting surface 10, deflection of light emitted from the light-emitting chips 12 is reduced. As shown in FIGS. 2 to 4, the lighting apparatus 1 includes a substrate 11, a plurality of light-emitting chips 12, and a light-emitting member 13. The lighting apparatus 1 further includes a reflecting member 14. In this embodiment, the term “upward direction” refers to the positive Z-axis direction in an imaginary XYZ space shown in FIG. 4.

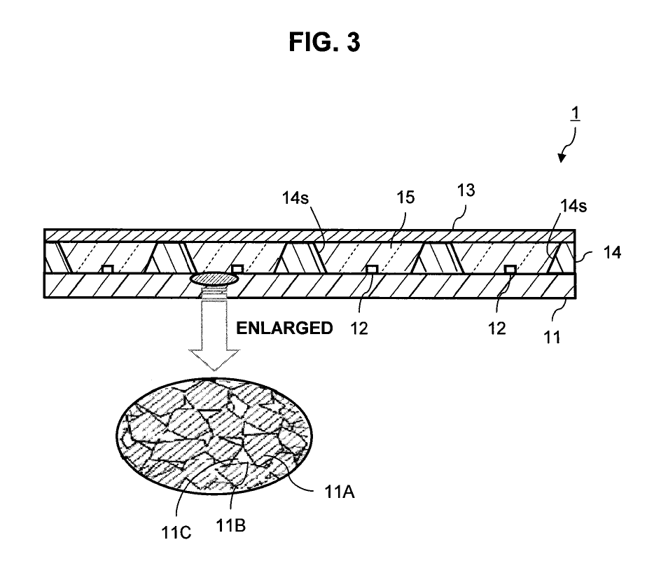

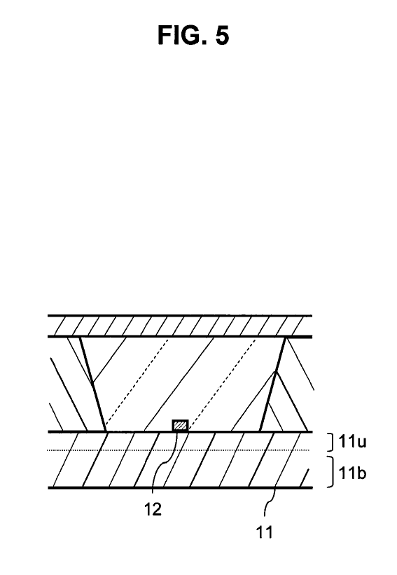

The substrate 11 includes an upper layer 11u and a lower layer 11b, as shown in FIG. 5. The upper layer 11u includes a base material 11A and a medium 11C, as shown in an enlarged view of FIG. 3. The base material 11A is formed of an inorganic material. The inorganic material is ceramics. The base material 11A includes a plurality of cells 11B. The base material 11A is formed by a plurality of inorganic particles. The base material 11A is porous. The term “porous” refers to a structure in which a plurality of inorganic particles 11A are partially combined so as to form a plurality of cells 11B. The medium 11C is provided in the cells 11B. That is, the medium 11C is dispersed in a matrix (base material 11A) formed of an inorganic material. The medium 11C has a refractive index lower than that of the inorganic material. For example, the medium 11C is gas. An example of gas is air. Another example of the medium 11C is resin. An example of resin is silicone. A further example of the medium 11C is glass. In this embodiment, the lower layer 11b includes a base material and a medium, similarly to the upper layer 11u.

The ratio of the cells 11B contained in the upper layer 11u is within the range of 15% to 43%. The ratio of the cells 11B is given by the following expression:

Ratio of cells 11B (%)

=(1−bulk density/true density)×100

The bulk density is measured by an Archimedian method. The true density is measured by a gas substitution method (that is, pycnometry).

The light-emitting chips 12 are mounted on the substrate 11. The light-emitting chips 12 are made of a semiconductor material. The light-emitting chips 12 emit first light having a first wavelength spectrum. The peak wavelength of the first light is within the wavelength range of 370 to 410 mm. The light-emitting chips 12 emit ultraviolet light. The light-emitting chips 12 are light-emitting diodes each including a substrate, an n-type semiconductor layer, a light-emitting layer, and a p-type semiconductor layer. The substrate is formed of sapphire. The n-type semiconductor layer is formed of n-GaN. The light-emitting layer is formed by a GaN active layer. The p-type semiconductor layer is formed of p-GaN. The light-emitting chips 12 are sealed in a layer 15 made of a transparent material. The term “transparency” for the layer 15 refers to the capability to transmit at least part of the wavelength of light emitted from the light-emitting chips 12.

The light-emitting member 13 is provided above the light-emitting chips 12. The light-emitting member 13 contains a fluorescent material. The light-emitting member 13 emits second light having a second wavelength spectrum different from the first wavelength spectrum. The light-emitting member 13 emits the second light in accordance with the first light. The light-emitting member 13 converts the wavelength of light emitted from the light-emitting chips 12. The light-emitting member 13 emits red light, green light, and blue light in accordance with the first light. The light-emitting member 13 is shaped like a sheet. The light-emitting member 13 contains silicone resin serving as a base material. The reflecting member 14 includes a plurality of light-reflecting faces 14s that surround the light-emitting chips 12.

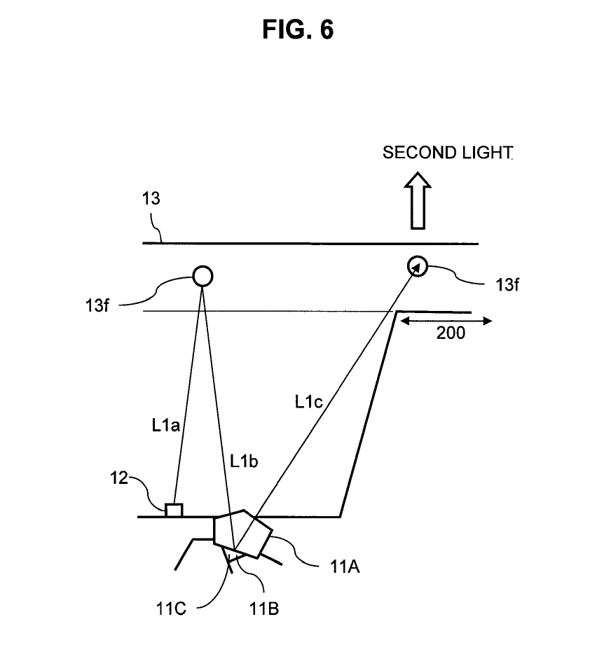

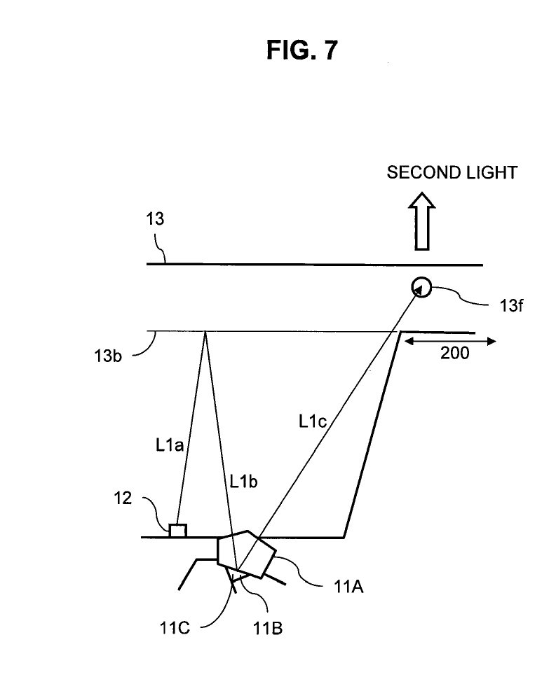

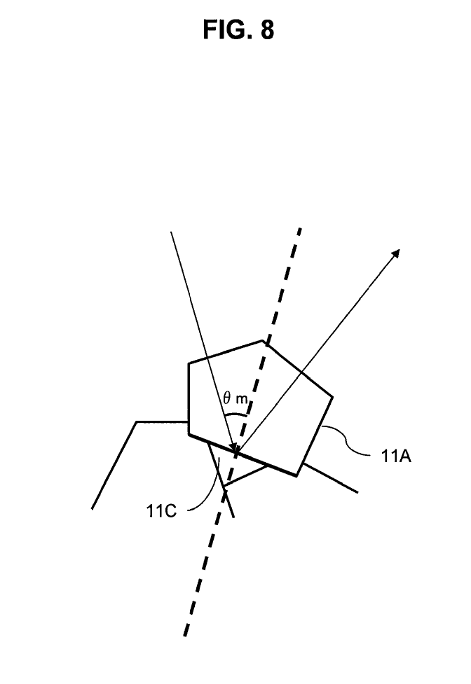

The way light travels in the lighting apparatus 1 will be described below with reference to FIGS. 6 and 7. As shown in FIG. 6, part of light L1a emitted from a light-emitting chip 12 is reflected downward by a fluorescent material 13f in the light-emitting member 13. The light L1b reflected by the fluorescent material 13 passes through an inorganic particle 11A. As shown in FIG. 7, part of the light L1a emitted from the light-emitting chip 12 is reflected downward by a lower surface 13b of the light-emitting member 13. As shown in FIGS. 6 and 7, the light L1b is reflected upward by an interface between the inorganic particle 11A and a medium 11C. The inorganic particles 11A and the medium 11C are different in refractive index. The light 1Lb travels upward by total reflection at the interface between the inorganic particles 11A and the medium 11C. The term “total reflection” means that incident light is reflected without passing through the interface between the inorganic particles 11A and the medium 11C having a lower refractive index when traveling from the inorganic particles 11A to the medium 11C. As shown in FIG. 8, the incident light is totally reflected when the incident angle thereof is more than or equal to a critical angle θm. The critical angle θm is given by the following expression using the refractive index n_{A} of the inorganic particles 11A and the refractive index n_{C} of the medium 11C:

sin θm=n_{C/n}_{A}

### In FIGS. 6 and 7, the light reflected upward by the interface is denoted by L1c. The light L1c travels to a region 200.

As shown in FIGS. 6 and 7, part of the light L1a emitted from the light-emitting chips 12 is reflected a plurality of times in the space between the light-emitting member 13 and the substrate 11, and then reaches the region 200. Since the light L1b is totally reflected by the substrate 11, the loss is reduced.

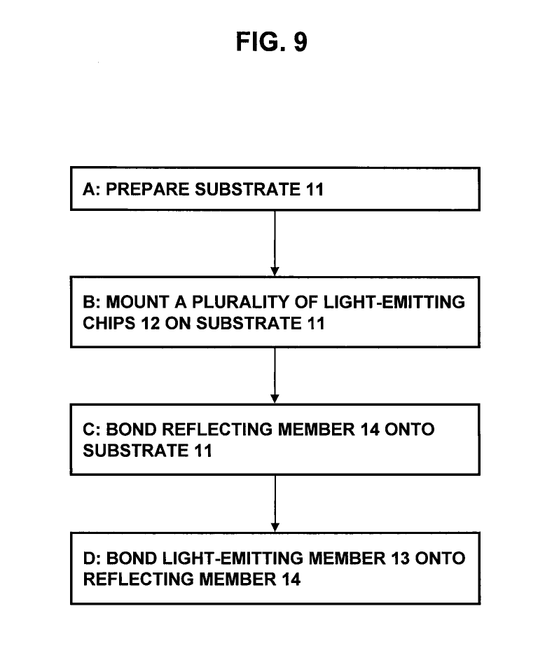

FIG. 9 explains a production method for the lighting apparatus 1 according to this embodiment. In Step A, a substrate 11 is prepared. In Step B, a plurality of light-emitting chips 12 are mounted on the substrate 11. In Step C, a reflecting member 14 is bonded onto the substrate 11. In Step D, a light-emitting member 13 is bonded onto the reflecting member 14.

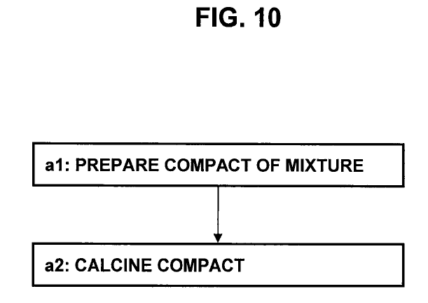

FIG. 10 explains details of Step A shown in FIG. 9. In Step a1, a compact formed by a mixture of a plurality of inorganic particles and binder resin is prepared. The inorganic particles are formed of alumina, yttrium, zirconia, titania, diamond, calcium oxide, or barium sulfate. The binder resin is acrylic resin, paraffin resin, or polyethylene resin. In Step a2, the compact is subjected to calcination. In this embodiment, the term “calcination” means to obtain a porous body including a plurality of inorganic particles while adjusting the calcination temperature or calcination time. The porosity of the porous body is within the range of 15% to 43%. The porosity of a typical calcined body is within the range of 0.001% to 1%. The binder resin in the mixture is removed by calcination. The medium 11C is gas contained in a plurality of cells 11B. When the medium 11C is glass or resin, the cells 11B are filled with melted glass or softened resin.

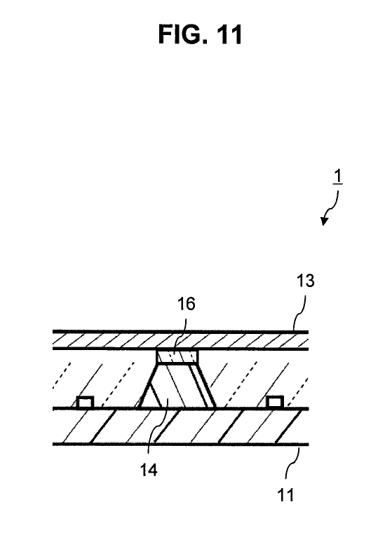

Another embodiment of the present invention will be described with reference to FIG. 11. A lighting apparatus 1 further includes a transparent material layer 16. The layer 16 is provided between a light-emitting member 13 and an upper surface of a reflecting member 14. The transparent material is resin. The resin is silicone. In this embodiment, the probability that light reflected by a substrate 11 will reach a fluorescent material in a region 200 is increased.

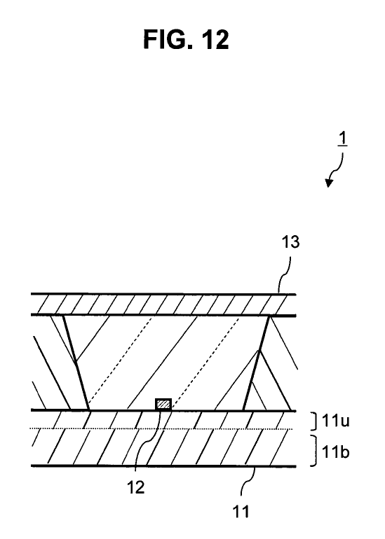

A further embodiment of the present invention will be described with reference to FIG. 12. An upper layer 11u of a substrate 11 includes a base material and a medium, similarly to the structure shown in FIG. 5. The ratio of a plurality of cells 11 in a lower layer 11b of the substrate 11 is lower than that of a plurality of cells in the upper layer 11u. The ratio of the cells in the lower layer 11b is within the range of 0.001% to 1%. In this embodiment, the heat radiation characteristic of the lighting apparatus is improved.

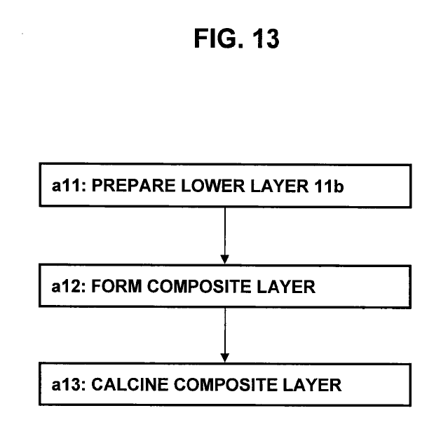

A production method for the lighting apparatus 1 according to this embodiment includes Steps A to D shown in FIG. 9. Details of Step A are described with reference to FIG. 13. In Step a11, a lower layer 11b is prepared. In Step a12, a composite layer including a plurality of inorganic particles and binder resin is formed. In Step a13, the composite layer is calcined.

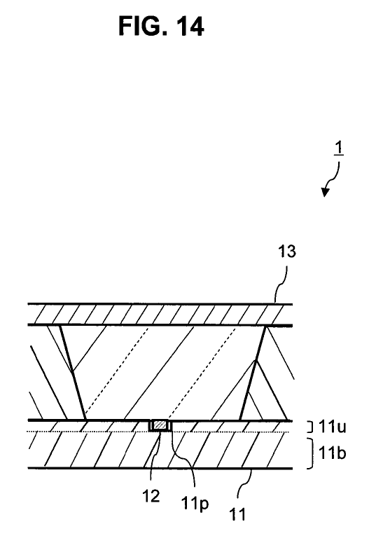

A further embodiment of the present invention will be described with reference to FIG. 14. An upper layer 11u of a substrate 11 includes a plurality of apertures 11p corresponding to a plurality of light-emitting chips 12. The light-emitting chips 12 are surrounded by inner surfaces of the apertures 11p. The light-emitting chips 12 are mounted on a lower layer 11b of the substrate 11. The ratio of a plurality of cells 11 in the lower layer 11b of the substrate 11 is lower than that of a plurality of cells in the upper layer 11u. In this embodiment, the heat radiation characteristic of the lighting apparatus 1 is improved.

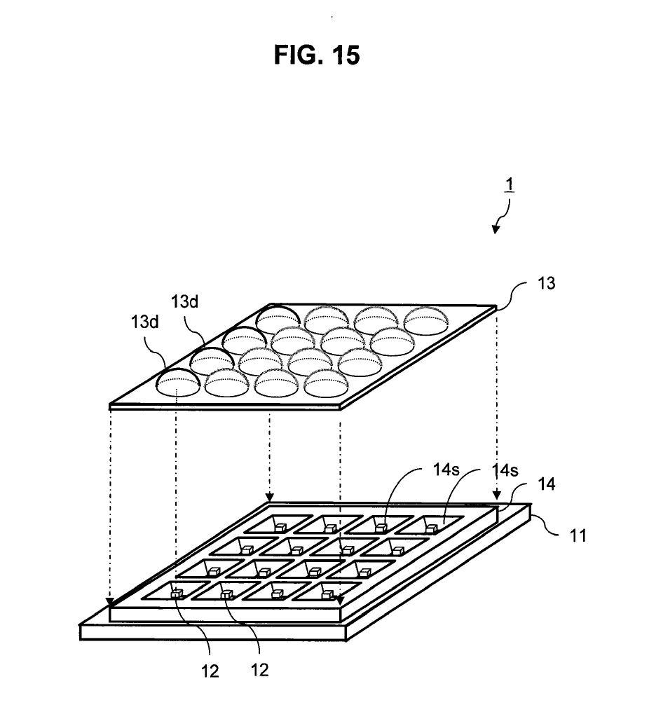

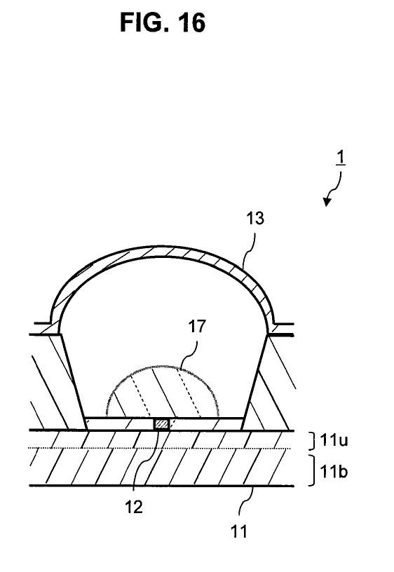

A still further embodiment of the present invention will be described with reference to FIG. 15. A light-emitting member 13 includes a plurality of dome-shaped portions 13d projecting upward. The portions 13b are disposed directly above a plurality of light-emitting chips 12. As shown in FIG. 16, a lighting apparatus 1 also includes a plurality of lenses 17 provided between the light-emitting chips 12 and the portions 13d. In this embodiment, non-uniform light emission from the lighting apparatus 1 is suppressed.

The present invention is not limited to the above-described embodiments, and modifications are possible without departing from the scope of the invention. For example, the medium may include two or more kinds of gasses, or may be a combination of at least two of gas, resin, and glass. Further, a surface layer thinner than the upper layer, for example, having a thickness of 1 to 100 μm may be provided on a surface of the upper layer.

1. A lighting apparatus comprising:
a substrate having a layer including a base material and a medium, the base material being formed of an inorganic material and including a plurality of cells, and the medium being provided in the cells and having a refractive index lower than that of the inorganic material;
a plurality of light-emitting chips made of a semiconductor material and mounted on the layer; and
a light-emitting member including a fluorescent material and provided above the light-emitting chips.

2. The lighting apparatus according to claim 1, further comprising:
a reflecting member including a plurality of light reflecting surfaces that surround the light-emitting chips.

3. The lighting apparatus according to claim 2, further comprising:
a transparent material layer provided between the light-emitting member and an upper surface of the reflecting member.

4. The lighting apparatus according to claim 1, wherein the inorganic material is ceramics.

5. The lighting apparatus according to claim 4, wherein the medium is gas.

6. The lighting apparatus according to claim 4, wherein the medium is formed of a resin material.

7. The lighting apparatus according to claim 4, wherein the medium is formed of a glass material.

8. The lighting apparatus according to claim 1, wherein the substrate further includes a lower layer in which the ratio of the base material is higher than in the upper layer.

9. The lighting apparatus according to claim 8, wherein the upper layer includes a plurality of apertures corresponding to the light-emitting chips.

10. The lighting apparatus according to claim 1, wherein the light-emitting member includes a plurality of dome-shaped portions provided immediately above the light-emitting chips and projecting upward.

11. The lighting apparatus according to claim 10, further comprising:
a plurality of lenses provided between the light-emitting chips and the portions.

12. A lighting apparatus comprising:
a plurality of light sources;
a wavelength converter provided above the light sources; and
a light reflector provided in at least a portion that surrounds the light sources, and configured to change the traveling direction of light by utilizing total reflection.

13. The lighting apparatus according to claim 12, wherein the light reflector is formed of at least two kinds of materials having different refractive indices, and total reflection is performed at an interface between the different materials.

14. The lighting apparatus according to claim 13, wherein the material having a lower refractive index is dispersed in the material having a higher refractive index.
